(19) United States
(12) Patent Application Publication
(10) Pub. No.: US 2026/0260474 A1
(43) Pub. Date: Sep. 3, 2026

(54) IMAGE CLASSIFICATION METHOD, AND CORRESPONDING ELECTRONIC DEVICE AND COMPUTER PROGRAM PRODUCT

(71) Applicant: Orange, Issy-les-Moulineaux (FR)

(72) Inventors: Jean-François Letellier, Chatillon (FR); Tiphaine Marie, Chatillon (FR)

(21) Appl. No.: 18/878,527

(22) PCT Filed: Jun. 26, 2023
(86) PCT No.: PCT/EP2023/067297

§ 371 Date: Dec. 23, 2024

(30) Foreign Application Priority Data
Jun. 29, 2022 (FR) FR2206563

(51) Int. Cl. G06V 10/82; G06N 3/09

(52) U.S. Cl. CPC G06V 10/82; G06N 3/09

(57) ABSTRACT

An image classification method is described. The method is implemented in an electronic device and includes obtaining images comprising a plurality of visual items, and distributing the images into a plurality of classes based at least on a number of occurrences, in the images, of visual items extracted from the images.

### 1. TECHNICAL FIELD

The present application relates to the field of the classification (or categorization) of digital elements comprising a representation of information consultable on a screen of an electronic apparatus, such as digital documents. These elements will also more simply be called “images” hereinafter.

The present application notably relates to a method for classification of such images by an electronic device, together with a corresponding electronic device, computer program product and recording (or information) medium.

### 2. PRIOR ART

Numerous technical fields implement image classification techniques. Some artificial intelligence techniques, such as the techniques known as “machine learning”, require the use a set of learning data, supplied as examples of classified data, so that a classification model can be learned. These techniques sometimes need the availability of a large set of learning data in order to obtain a relevant model. This is often the case for image classification techniques based on neural networks. Such techniques may for example require of the order of several thousands or of millions of learning data. For example, a widely used set of data, such as that of the challenge (ImageNet Large Scale Visual Recognition Challenge (ILSVRC 2012-2017)), comprises more than a million learning images.

The preparation (notably the annotation) of these sets of learning data can be a long and tedious task.

The aim of the present application is to provide improvements to at least some of the drawbacks of the prior art.

### 3. DESCRIPTION OF THE INVENTION

The present application aims to improve the situation by means of a method for the classification of images implemented in an electronic device comprising:
obtaining images comprising a plurality of visual items;
distributing the images into a plurality of classes, according to at least one occurrence, within said images, of visual items extracted from said images.

For example, the present application relates to a method for classifying images implemented in an electronic device and comprising:
obtaining images comprising a plurality of visual items;
distributing the images into a plurality of classes, according to at least a number of occurrences, within said images, of visual items extracted from said images.

Here, ‘image’ is understood to mean, as explained hereinabove, a representation of information consultable on a screen of an electronic apparatus, such as digital documents.

According to at least one embodiment, said classes are identified during said distribution.

According to at least one embodiment, said method comprises a labeling of the identified classes.

According to at least one embodiment, said labeling is carried out automatically.

According to at least one embodiment, said images distributed into said plurality of classes are used to train a neural network to classify other images according to said plurality of classes.

According to at least one embodiment, said method is implemented locally to said electronic device.

According to at least one embodiment, said images are obtained via a software probe and/or a digitization device.

According to at least one embodiment, said images comprise at least one digital document accessible to said device.

According to at least one embodiment, said visual items are words, groups of words and/or graphical objects from said images.

According to at least one embodiment, the method comprises a replacement of at least a first word, from amongst said visual items, by at least a second word.

According to at least one embodiment, said at least a second word is a generic word or group of words describing a type of said first word.

For example, the “first” words “Dupond” and “Durand” may both be replaced by the same “second” word “Surname”.

According to at least one embodiment, said method comprises obtaining the positions of said extracted visual items within said plurality of images.

According to at least one embodiment, said visual items are words and/or groups of words and said method comprises, for an analyzed image from said plurality of images, an association with said analyzed image of the numbers of occurrences of the individual visual items extracted from said analyzed image.

According to at least one embodiment, said method comprises the elimination, within said individual visual items associated with said analyzed image, of at least one stop word.

According to at least one embodiment, said method comprises the elimination, within said individual visual items associated with the analyzed images from said plurality of images, of the visual items associated with a number of images greater than a desired number of classes.

According to at least one embodiment, said method comprises:
a grouping of the individual visual items from said analyzed image taking into account various values of said numbers of occurrences of individual visual items within said analyzed image;
obtaining at least one candidate distribution of said images for a candidate value of the various numbers of occurrences, taking into account individual visual items common to at least two analyzed images grouped for said candidate value.

According to at least one embodiment, said distribution takes into account patterns, relating to the positions of said visual items within said images from said plurality of images, and present in at least two analyzed images from said plurality of images.

According to at least one embodiment, said method comprises:
a detection of at least one pattern within the analyzed images from said plurality of images;
an association of said pattern detected with the analyzed images from said plurality of images in which an occurrence of said pattern has been detected;
obtaining at least one candidate distribution of said analyzed images taking into account at least one occurrence of at least one pattern associated with at least two of said analyzed images.

According to at least one embodiment, said distribution takes into account the positions of said patterns within said analyzed images.

According to at least one embodiment, said method comprises an assignment of a confidence score to a class, taking into account a presence of at least one visual item associated with at least one image of said class, in at least one other image of at least one other class.

According to at least one embodiment, said method comprises obtaining at least two candidate distributions and said distribution is chosen from amongst said candidate distributions, taking into account a desired number of classes and/or the confidence score assigned to at least one of the classes of said candidate distributions.

According to at least one embodiment, said method comprises a modification of at least one of said images obtained prior to an analysis of said images.

According to at least one embodiment, the method comprises an association of a textual wording with at least one of said classes.

According to at least one embodiment, the method comprises a rendering of at least one of said images and said wording associated with the class of said rendered image is obtained from a user interface of said device.

The features, described in isolation in the present application in conjunction with some embodiments of the method of the present application, may be combined with one another according to other embodiments of the present method.

According to another aspect, the present application also relates to an electronic device designed to implement the method of the present application in any one of its embodiments. For example, the present application thus relates to an electronic device comprising at least one processor configured for an image classification comprising:
obtaining images comprising a plurality of visual items;
distributing the images into a plurality of classes, according to at least one occurrence within said images, of visual items extracted from said images.

For example, the present application also relates to an electronic device comprising at least one processor configured for an image classification comprising:
obtaining images comprising a plurality of visual items;
distributing the images into a plurality of classes, according to at least a number of occurrences, within said images, of visual items extracted from said images.

The present application also relates to a computer program comprising instructions for the implementation of the various embodiments of the method hereinabove, when the program is executed by a processor and a recording medium readable by an electronic device and on which the computer program is recorded.

For example, the present application thus relates to a computer program comprising instructions for the implementation, when the program is executed by a processor of an electronic device, of a method for classifying images comprising:
obtaining images comprising a plurality of visual items;
distributing the images into a plurality of classes, according to at least one occurrence, within said images, of visual items extracted from said images.

For example, the present application also relates to a computer program comprising instructions for the implementation, when the program is executed by a processor of an electronic device, of a method for classifying images comprising:
obtaining images comprising a plurality of visual items;
distributing the images into a plurality of classes, according to at least a number of occurrences, within said images, of visual items extracted from said images.

For example, the present application also relates to a recording medium (or information medium) readable by a processor of an electronic device and on which a computer program is recorded comprising instructions for the implementation, when the program is executed by the processor, of a method for classifying images comprising:
obtaining images comprising a plurality of visual items;
distributing the images into a plurality of classes, according to at least one occurrence, within said images, of visual items extracted from said images.

For example, the present application also relates to a recording medium readable by a processor of an electronic device and on which a computer program is recorded comprising instructions for the implementation, when the program is executed by the processor, of a method for classifying images comprising:
obtaining images comprising a plurality of visual items;
distributing the images into a plurality of classes, according to at least a number of occurrences, within said images, of visual items extracted from said images.

The programs mentioned hereinabove may use any given programming language and may take the form of source code, object code, or of code intermediate between source code and object code, such as in a partially compiled form, or in any other desired form.

The aforementioned information media (or recording media) may be any given entity or device capable of storing the program. For example, a medium may comprise a storage means, such as a ROM, for example a CD ROM or a microelectronic circuit ROM, or else a magnetic recording means.

Such a storage means may for example be a hard disk, a flash memory, etc.

Furthermore, an information medium may be a transmissible medium such as an electrical or optical signal, which may be transmitted via an electrical or optical cable, by radio or by any other means. A program according to the invention may, in particular, be up/downloaded over a network of the Internet type.

Alternatively, an information medium may be an integrated circuit in which a program is incorporated, the circuit being designed to execute or to be used in the execution of any one of the embodiments of the method subject of the present patent application.

### 4. BRIEF DESCRIPTION OF THE DRAWINGS

Other features and advantages of the invention will become more clearly apparent upon reading the following description of particular embodiments, given by way of simple illustrative and non-limiting examples, and from the appended drawings, amongst which:

FIG. 1 shows a simplified view of a system, cited by way of example, in which at least some embodiments of the method of the present application may be implemented,

FIG. 2 shows a simplified view of a device designed to implement at least some embodiments of the method of the present application;

FIG. 3 shows a view of the method of the present application, in at least some of its embodiments;

FIG. 4 shows in more detail certain processing operations of the method of the present application, in some embodiments compatible with the embodiments illustrated in FIG. 3;

FIG. 5 shows in more detail certain processing operations of the method of the present application, in some embodiments compatible with the embodiments illustrated in FIG. 3;

FIG. 6 shows in more detail certain processing operations of the method of the present application, in some embodiments compatible with the embodiments in FIGS. 4 and 5;

FIG. 7 shows, schematically and summarily, exchanges of streams between some of the devices of the system 100 for the implementation of the method of the present application, in at least some of its embodiments;

FIG. 8 shows one example of patterns used in the framework of the embodiments illustrated in FIG. 5.

### 5. DESCRIPTION OF THE EMBODIMENTS

The present application provides an automatic (or at least partially automatic) classification of images. More precisely, the present application provides, in at least some embodiments, the use of automatic image analysis techniques in order to obtain, from these images, data characterizing elements shown by these images. These elements are for example textual elements, such as words or groups of words, or graphical objects occupying a portion of image. These data will subsequently be used to distribute the images into various classes, or categories (also referred to as “clusters”).

By virtue of this distribution into classes, or clustering, the method of the present application, in at least some of its embodiments, may help to easily label (in other words, to annotate) a large set of images by for example assigning one or more same labels to all the images of a class (or category). These labelled images may for example subsequently be used as learning data in the framework of a supervised training (for example for the training of a neural network designed to classify other images during its inference).

Since this automatic classification (or categorization) facilitates the labelling of images, it may additionally help, in at least some embodiments of the method of the present application, to develop the classes of a neural network over time (by successive learning phases on variable data sets).

An automatic classification of images may also allow images to be automatically labelled without the intervention of an operator (for example by automatically assigning label to the classes (such as successive numbers) and by potentially subsequently offering to an operator the possibility of modifying as he/she likes the labels of the classes). As a result, an automatic classification of images may therefore offer, at least in certain embodiments, advantages in terms of confidentiality of the images (which may for example correspond to personal data of an individual or group of individuals), and/or of speed of processing. Such an automatic classification may also help to avoid, or at least to limit, the input errors, and to simplify the choice of assignment of a class (or category) to an image, in cases of distribution according to quite complex criteria, or when the number of classes (or clusters) is high (for example of the order of a few tens of classes).

An automatic classification of images, when the latter correspond to acquisitions or digitizations of administrative documents, may also offer advantages in terms of reliability, speed and/or confidentiality for the electronic archiving of administrative documents. For example, by virtue of the method of the present application, in at least some of its embodiments, a user can scan a stack of documents and automatically obtain a distribution of these documents into classes (pay slips, bank statements, social security statements, etc.) that he/she just needs to archive separately accordingly.

According to yet another example, an automatic classification of learning data may also allow, in at least some embodiments, a training (for example federated training) of neural networks using, for the training of a neural network with a view to an inference on a device, self-labelled data local to this device, so as for example to meet obligations linked to a protection of personal data.

The method of the present application may be implemented for classifying various types of images. For example, as highlighted hereinbefore, in some digitization (or scanning) embodiments, these may be various types of digital documents: administrative documents (birth certificates, death certificates, etc.), commercial documents (invoices, delivery notes, purchase orders, etc.), till receipts, etc. In certain embodiments, the method may involve an classification of images of products or of objects (represented in the images) (for example with a view to the production of a sales catalogue).

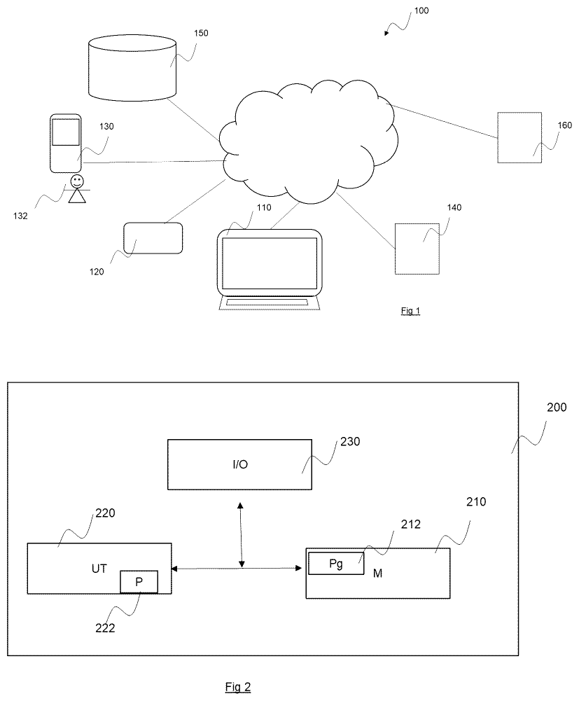

The present application is now described in more detail with reference to FIG. 1. FIG. 1 shows a telecommunications system 100 in which at least some embodiments of the invention may be implemented. The system 100 comprises one or more electronic devices, where at least some of them may communicate with one another via one or more communications networks, potentially interconnected, such as a local area network or LAN and/or a network of the non-local type, or WAN (for Wide Area Network). For example, the network may comprise a business or home LAN network and/or a WAN network of the internet or cellular type, GSM—Global System for Mobile Communications, UMTS—Universal Mobile Telecommunications System, Wifi—Wireless, etc.

As illustrated in FIG. 1, the system 100 may also comprise several electronic devices, like a terminal (such as a portable computer 110, a smartphone 130, a tablet 120), a server 140, and a storage device 150, on which parameters of a neural network may for example be stored, such as parameters relating to its structure (for example a description of its various layers, the number and the sizes of the matrices respectively associated with these layers, etc.) and the current values of the coefficients of the matrices associated with these layers. The server 140 may for example use learning data, for example previously stored on the storage device or on another of the devices of the system, in order to refine the values of the coefficients of the neural network during an (optional, for example, prior) training phase of the neural network.

One of the terminals 110, 120, 130 may also obtain, from the storage device for example, the current parameters of the neural network (including the current values of the coefficients, potentially learned in a prior phase by virtue of the server or of another terminal) and carry out a “local” training of the neural network in order to refine the values of the coefficients depending, for example, on learning data specific to the terminal, such as data stored locally by the terminal or stored remotely but accessible to the terminal and relating to the terminal.

The learning data used by the server and/or the terminal may have been obtained by at least some embodiments of the method of the present application.

The system may also comprise management and/or interconnection network elements (not shown). These electronic devices may be associated with at least one user 132 (by means for example of a user account accessible by login), where some of the electronic devices 110, 130 may be associated with the same user 132. The system may also comprise a database 160, such as a lexical database.

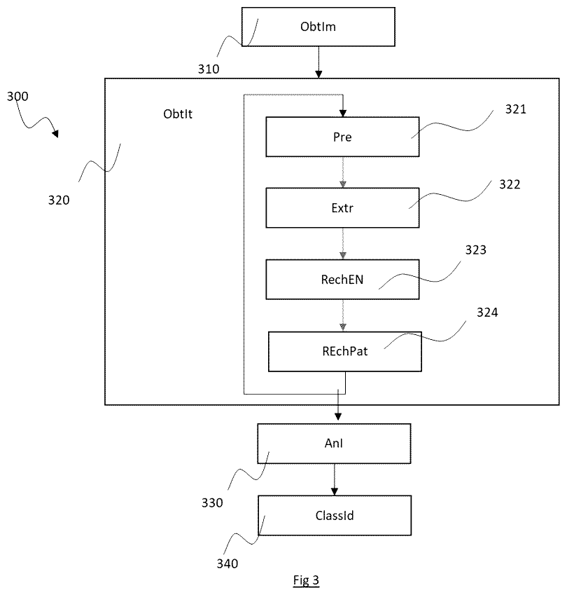

FIG. 2 illustrates a simplified structure of an electronic device 200 of the system 100, for example the device 110, 130 or 140 in FIG. 1, designed to implement the principles of the present application. According to the embodiments, this device may be a server and/or a terminal.

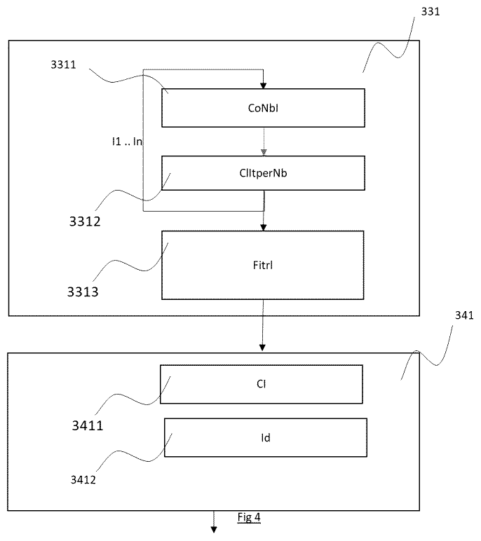

The device 200 notably comprises at least one memory M 210. The device 200 may notably comprise a buffer memory, a volatile memory, for example of the RAM (for “Random Access Memory”) type, and/or a non-volatile memory, for example of the ROM (for “Read Only Memory”) type. The device 200 may also comprise a processing unit UT 220, equipped for example with at least one processor P 222 and controlled by a computer program PG 212 stored in memory M 210. Upon initialization, the code instructions of the computer program PG are for example loaded into a RAM memory prior to being executed by the processor P. The at least one processor P 222 of the processing unit UT 220 may notably implement, individually or collectively, any one of the embodiments of the method of the present application (notably described in relation to FIG. 3), according to the instructions of the computer program PG.

The device may also comprise, or be coupled to, at least one input/output module I/O 230, such as a communications module, allowing for example the device 200 to communicate with other devices of the system 100, via wired or wireless communications interfaces, and/or such as a module for interfacing with a user of the device (also more simply referred to as “user interface”) in the present application.

A “user interface” of the device is for example understood to mean an interface integrated into the device 200 or a part of a third-party device coupled to this device via wired or wireless communications means. For example, the interface may consist of a secondary screen of the device or of a set of loudspeakers connected via a wireless technology to the device.

A user interface may notably be an “output” user interface designed for a rendering (or for the control of a rendering) of an output element of a data processing application used by the device 200, for example an application being executed at least partially on the device 200 or an “online” application being executed at least partially remotely, for example on the server 140 of the system 100. Examples of an output user interface of the device include one or more screens, notably at least one graphical screen (for example a touch screen), one or more loudspeakers and/or a connected headset.

Here “rendering” is understood to mean an output on at least one user interface, in any given form, for example comprising textual, audio and/or video components, or a combination of such components.

On the other hand, a user interface may be an “input” user interface designed for an acquisition of information coming from a user of the device 200. This may notably be information intended for a data processing application accessible via the device 200, for example an application being executed at least partially on the device 200 or an “online” application being executed at least partially remotely, for example on the server 140 of the system 100. Examples of an input user interface of the device 200 include a sensor, a means of audio and/or video acquisition (microphone, camera (webcam) for example), a keyboard, a mouse.

The device may also comprise at least one software module (or software probe) designed to capture data input or rendered on the user interface of the device.

Said at least one microprocessor of the device 200 may notably be designed for an image classification comprising:
obtaining images comprising a plurality of visual items;
distributing the images into a plurality of classes, according to at least one occurrence, within said images, of visual items extracted from said images.

Said at least one microprocessor of the device 200 may notably be designed for an image classification comprising:
obtaining images comprising a plurality of visual items;
distributing the images into a plurality of classes, according to at least a number of occurrences, within said images, of visual items extracted from said images.

Some of the input-output modules hereinabove are optional and may therefore be absent from the device 200 in some embodiments. Notably, although the present application is sometimes detailed in conjunction with a device communicating with at least a second device of the system 100, the method may also be implemented locally by a device, using for example, as input element, elements acquired for example by software and/or hardware probes being executed on the device, in order to produce output elements stored locally on the device, or rendered via an output interface of the device.

On the other hand, in some of its embodiments, the method may be implemented in a distributed manner between at least two devices 110, 120, 130, 140 and/or 150 of the system 100.

Here, the term “module” or the term “component” or “element” of the device is understood to mean a hardware element, notably wired, or a software element, or a combination of at least one hardware element and of at least one software element.

The method according to the invention may therefore be implemented in various ways, notably in a wired form and/or in a software form.

FIG. 3 illustrates some embodiments of the method 300 of the present application.

The method 300 may for example be implemented by the electronic device 200 illustrated in FIG. 2.

As illustrated in FIG. 3, the method 300 may comprise the acquisition 310 of a set (or batch) of images to be classified.

As illustrated in FIG. 3, the method 300 may comprise the acquisition 320 of visual items extracted from the images obtained. In the present application, a “visual item” is understood to mean a word, a group of words or a graphical object. This acquisition may comprise a search 322 for visual items in the acquired images (or, as a variant, access to at least one file associated with at least one of the acquired images and comprising visual items previously extracted from this image). The search 322 may for example, in some embodiments, implement techniques for analyzing images and/or for detecting elements shown by these images, such as character recognition techniques (for example OCR (for “Optical Character Recognition”) techniques) leading to an extraction of words(s) from the images. These techniques may also include, for example, shape and/or object recognition and/or image segmentation techniques.

In the case where the search 322 allows words to be identified in one of the acquired images, the method may also comprise a search 323 for at least one named entity in the extracted words by comparison with the elements of a lexical database for example (such as for example the element 160 of the system 100).

Such a search may for example comprise an execution of a service accessible to the device 200, for example a software library service (such as the “Allganize” © service), responsible for detecting, in a text (here in words extracted from an analyzed image), words considered by the service as being of a particular type (such as a surname, a first name, an address, a telephone number, an organization); the method may also comprise a replacement (for example via a service such as introduced hereinabove), in this text, of the words having one of these particular types, by a generic word, or group of words describing this particular type (and subsequently called “named entity”).

Examples of named entities may comprise the terms “surname”, “first name”, “address”, “telephone number”, “organization”). For example, the group of words “Jean Dupont lives in Clermont-Ferrand” could become: “First Name Surname lives in Town”.

This search 323 for named entity(ies) may be optional in some embodiments.

In some embodiments, the method 300 may comprise, prior to a search (and extraction) of visual items from at least one image, a preprocessing 321 of at least one of the acquired images, in order for example to facilitate the extraction of visual items from the image.

This may for example, in at least one embodiment, consist of the application of at least one image processing technique. According to a first example, such a technique may be a color transformation (for example a conversion) applied to at least one of the acquired images, so as to only conserve, in the transformed image, colors corresponding to various grey levels. Another technique may, according to another example, be a transformation, applied to at least one of the acquired images, making the contrasts vary within the image (for example in order to increase the contrasts) and/or modifying the brightness of the image.

This preprocessing may be optional in some embodiments.

The detection and/or the extraction of visual items from the acquired (and potentially preprocessed) images may also allow, in some embodiments, not only visual items present in an image to be identified but also their positions within this image to be obtained.

Following the extraction of visual items from the analyzed images (and the potential search for named entity(ies)), for each image on which the extraction has been carried out, a list of visual items extracted from this image and potentially their positions in this image are therefore obtained.

As illustrated in FIG. 3, the method 300 may comprise an analysis 330 of the visual items obtained (for example the words and named entities extracted from the images), in order to distribute 340 the images into a plurality of classes (or clusters) taking into account these visual items.

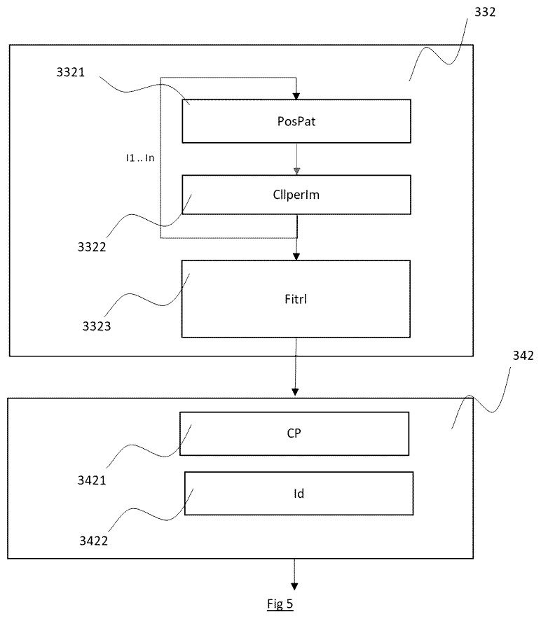

The analysis 330 and the distribution 340 based on this analysis that are performed may depend on the embodiments. Thus, according to some embodiments illustrated in FIG. 4, the analysis 331 (and hence the distribution 341) may be based on a number of occurrences of visual items of the word or group of words type extracted from the analyzed images. According to other embodiments illustrated in FIG. 5, the analysis 332 (and hence the distribution 342) may be based on a presence of “patterns” in the analyzed images relating to the positioning of certain visual items within the images.

FIG. 4 thus illustrates in more detail one example of an analysis 331 of the images and associated visual items and of a distribution 341 of these images based on a number of occurrences of the visual items in the analyzed images.

In the example illustrated in FIG. 4, the analysis 331 of an image is based on the visual items obtained 320 (FIG. 3) from this image (and associated with this analyzed image). More precisely, the analysis 331 comprises, for at least one visual item associated with the analyzed image, counting 3311 of the number of occurrences, in the analyzed image, of this visual item, in other words of the number of times where this visual item (word or named entity) appears in this image. The analysis may also comprise a classification (or grouping) 3312 of the visual items associated with the analyzed image according to their number of occurrences (so as for example to group together in a first group all the visual items only appearing once in the analyzed image, then in a second group all the visual items appearing exactly twice in the analyzed image, etc.). For each analyzed image, one or more lists of visual items is therefore obtained, each list being dedicated to a distinct number of occurrences.

The pseudo-code hereinafter thus represents, by way of example, the groupings ClaWordImg[1] . . . . ClaWordImg[n] respectively obtained for an image from amongst the plurality of analyzed images I₁ . . . Iₙ:

ClaWordImg[1]:
{
1:[‘word_ggg’, ‘word_ddd’, ‘word_aaa’, ‘word_sss' , ‘word_ttt’ , ‘word_vvv’, ‘word_ppp’ ,
‘word_zzz’],
2:[‘word_mmm’, ‘word_ooo’ , ‘word_nnn’ , ‘word_yyy’ , ‘word_iii’ , ‘word_kkk’],
...
}
...
ClaWordImg[n]:
{
1:[‘word_ggg’, ‘word_ddd’, ‘word_aaa’ , ‘word_sss' , ‘word_eee’ , ‘word_bbb’],
2:[‘word_xxx’, ‘word_hhh’ , ‘word_rrr’ , ‘word_jjj’],
...
...
}

As shown in FIG. 4, the analysis may comprise a filtering 3313 of some of the visual items associated with an image. In the example in FIG. 4, this filtering may for example comprise the elimination of visual item(s) not useful for the classification of the images. For example, the method may comprise the elimination of at least one stop word, sometimes referred to as “transition word”, “link word” or “portmanteau word” (such as an article, or a linking word). The method may also comprise, in some embodiments, the elimination of the items appearing in a large number of images.

Since the classification of the images is subsequently carried out according to the visual items extracted from the images, a visual item present in a number of images greater than a desired number of classes in the distribution would indeed not be very useful for distinguishing images in view of their distribution.

Similarly, in some embodiments, the visual items associated with a number of images close to the number of images to be classified (for example associated with more than 90% of analyzed images) may be eliminated in some embodiments. In addition, the inventors have noted that certain elements, such as a logo or certain words (for example “Pay” or “Invoice” in the case of an administrative type of document), were often present a small number of times in an image while at the same time being characteristic of a type of images. For this reason, certain embodiments, such as the embodiments detailed, may give priority to the low numbers of occurrences and eliminate the items associated for example with a number of occurrences higher than a first number of occurrences (used as a high threshold for example).

According to the embodiments, for example depending on the filtering carried out, this filtering may be carried out at least partially before and/or after the grouping by numbers of occurrences.

Thus, the filtering of the unnecessary words may for example be carried out prior to the grouping of the visual items according to their number of occurrences, in order to help improve processing efficiency for example during this grouping.

The filtering may be optional in some embodiments (for example, it may be activated or otherwise via a configuration parameter).

The pseudo-code hereinafter thus represents, for the plurality of analyzed images I₁ . . . Iₙ, the groupings ClaWordImg[1] . . . ClaWordImg[n] previously introduced once the latter have been filtered:

ClaWordImg[1]:
{
1:[‘word_aaa’, ‘word_sss', ‘word_ttt’, ‘word_vvv’, ‘word_ppp’, ‘word_zzz’],
2:[‘word_mmm’, ‘word_ooo’, ‘word_nnn’, ‘word_yyy’, ‘word_iii’, ‘word_kkk’],
...
}
...
ClaWordImg[n]:
{
1:[‘word_aaa’, ‘word_sss’, ‘word_eee’, ‘word_bbb’],
2:[‘word_xxx’, ‘word_hhh’, ‘word_rrr’, ‘word_jjj’],
...
}
It can be seen that the items ‘word-ggg’ and ‘word-ddd’ have for example been
eliminated from the groupings ClaWordImg[1] and ClaWordImg[n].

The groupings of visual items by number of occurrences for each analyzed image may be used to distribute 341 the images into classes. As shown in FIG. 4, the method may comprise obtaining a candidate distribution for at least one value k of the number of occurrences of visual items. According to the embodiments, this may be a value of “k” particular to each analyzed image or common to all the analyzed images. More precisely, in some embodiments, the method may comprise a search 3411 for items common to several images corresponding to a given number k of occurrences, allowing these images to be grouped into “x” clusters (where x is the number of desired classes). The idea here is to identify a class of the candidate distribution via a list of items common to the images of this class. For example, the maximum of common words is sought in the analyzed images allowing the images to be differentiated by grouping them into “x” clusters. The pseudo-code hereinafter thus represents examples of classes (or clusters) obtained for the plurality of analyzed images 11. In, in conjunction with the examples of pseudo-code previously introduced.

Cluster[1]:
{
data:[3, 25, ...., n−1, n],
bestNbOccurrence: 1,
words: [ ‘word_aaa’, ‘word_sss'],
confidenceLevel: 0.89
}
Cluster[2]:
{
data:[1, 4, 5, ..., ...],
bestNbOccurrence: 1,
words:[ ‘word_fff’, ‘word_ppp’, ‘word_zzz’],
confidenceLevel: 0. 92
}
...

The association and identification steps may be carried out for several values of occurrence k of certain images, for example until a number of classes corresponding to the number x of desired classes is found.

For example, in some embodiments, a first candidate distribution may be obtained for a first value of k, common to the images, chosen so as to correspond to the smallest occurrence number of items over all the images (k=1 for example), at least a second candidate distribution being obtained for at least a second value of occurrences, greater than the first value chosen for the first distribution. For example, candidate distributions may be obtained for higher and higher successive values of the number of occurrences, until a desired number of classes is obtained or until an occurrence number is reached corresponding to the highest occurrence number associated with all of the images (in other words the minimum value, over all of the analyzed images, of the highest number of occurrences associated with each of these images).

In some embodiments, the identification of classes may for example take into account a minimum or maximum number or percentage of images per class, so as to obtain relatively uniform classes, and/or a desired number x of classes for example, as explained hereinbefore.

In some embodiments, the desired number of classes may not be fixed, where a minimum and/or maximum number of occurrences to be used for the various images may for example be defined. Various values of occurrences may for example be tested in order to arrive at a classification of all of the images complying with this minimum and/or maximum number of occurrences.

In some embodiments, when the desired number of classes is not fixed, the choice of a distribution, from amongst the candidate distribution or distribution(s), may take into account a confidence level associated with the distribution (or with at least one class of the distribution). For example, the distribution chosen may be the first candidate distribution obtained associated with a confidence level higher than a first value (this first value may be a configuration parameter or be deduced from such a parameter).

Thus, in some embodiments, candidate distributions may be sought for all the numbers of occurrences less than or equal to the highest number of occurrences common to all the images, the method subsequently comprising a selection of the candidate distribution having the best confidence score.

In some embodiments, the method may comprise an assignment of a confidence score to at least one class (for example to each class) of at least one of the candidate distributions.

This assignment may be optional in some embodiments.

For example, in embodiments compatible with the illustration in FIG. 4, a confidence level may be assigned to each item associated with a class, this confidence level being for example calculated taking into account the number of classes in which the item is present. More precisely, the confidence level of an item in a class may be calculated in some embodiments as a ratio between the number of images belonging to this class where this item appears, and the total number of images (in all of the classes) where the visual item is present.

A confidence score, within the class in question, may for example be calculated taking into account the respective confidence levels of the items in the class. For example, the calculation of the confidence score of the cluster may be based on the average of the confidence levels of the items, over the standard deviation relating to these confidence levels etc.

The score of a class may, in certain embodiments, take into account the compliance with at least one criterion relating to the values of the confidence levels of the items that are associated with it. For example, a value of a confidence level, for one of the items of the class, lower than a first value (for example a “threshold” value) may degrade (for example decrease) or in other embodiments improve (for example increase) the confidence score of the class (via a multiplier coefficient for example). In the same way, a value of a confidence level, for one of the items of the class, higher than a second value (for example a “threshold” value) may improve or in other embodiments degrade the confidence score of the class.

Similarly, a global score may be assigned to a candidate distribution taking into account confidence scores of all of the various classes of the distribution.

The method may furthermore comprise a selection of a distribution (called chosen or selected distribution) from amongst the candidate distributions. One of the selection criteria may for example take into account the global score obtained for a candidate distribution. Another example of a selection criterion may for example be the compliance with at least one configuration parameter such as that detailed hereinafter.

FIG. 5 thus illustrates, in more detail, one example of analysis 332 and of distribution 342 based on a presence of patterns in the analyzed images, and optionally on the positions of these patterns within the analyzed images.

In some embodiments, following the search (and the detection) 322, 323 of visual elements (step 320), the method may comprise a search 324 for at least one pattern, in terms of occupation of blocks by particular visual items, within an image or between the analyzed images, i.e. of a repetition of an occupation of one or more blocks by one or more first visual items within the same image (intra-image pattern) or between at least two analyzed images (inter-image pattern). This may for example be a fixed pattern or a floating pattern. A fixed pattern corresponds to a repetition (potentially with a scale factor, such as a multiplier coefficient, in some embodiments), within at least m analyzed images (with m an integer greater than or equal to 2, for example definable by configuration), of a set of occupied block(s) with the same relative positioning(s) (i.e. with the same offsets) with respect to a fixed reference position (for example an origin (0;0)) between these at least two images. Thus, for example, a fixed pattern may correspond to a repetition of an identical set of occupied blocks with the same indices within several images. In some embodiments, the visual items of a pattern are identical between the repetitions of the pattern. For example, a pattern may correspond to a repetition of the sequence of the visual items of 3 named entities such as surname, first name, timing, distributed over 3 consecutive blocks.

FIG. 8 thus illustrates three images 810, 820, 830, certain blocks (with hatching) of which are occupied by visual items. The groups of occupied blocks 811, 812, 813 present over several images correspond to patterns (fixed). These patterns may have various shapes, more or less complex, as is illustrated by the element 831 of the image 830 (this element is not present in the images 810 and 820 but is assumed to be present in the framework of this example in at least one other image not shown).

A sliding pattern has a repetition (potentially with a scale factor (such as a multiplier coefficient) in some embodiments), in at least two analyzed images, of a set corresponding to a set of occupied block(s) with the same relative positioning(s) (for example with the same offset), with respect to a reference position, able to vary within an image or between different images.

According to the embodiments, the method may only search for the fixed patterns or may search for the fixed patterns and the floating patterns, or may be limited to the fixed patterns and to floating patterns whose position, although variable, is situated within a certain portion of image (e.g.: right side of the images, center or left side, etc.). The visual items of a pattern may be of various types. For example, a pattern may comprise at least one word, at least one named entity and/or at least one graphical object (for example a logo). In the case of textual items, the search for at least one pattern may thus take into account a repeated proximity between at least one named entity and at least one word, and/or a proximity between at least two named entities, and/or of a proximity between at least two words.

Once the fixed and/or floating patterns have been detected, the method may comprise an analysis 332 of at least some of the acquired images 310, based on the patterns (fixed and/or floating) detected during the search hereinabove.

In some embodiments, the method may comprise a search 324 for a presence of at least one pattern within an image and (optionally) an association 3321 with the patterns present in this image of their position(s) within this image.

For example, for an analyzed image, a first pattern P1, present several times within the image, will be associated with its positions (pos 11, pos 12, pos 13) within this image, a second pattern P2, present only once within the analyzed image, will be associated with its sole position pos21 within the image.

As in the embodiments illustrated in conjunction with FIG. 4, a filtering 3322 (optional) may be performed on the patterns associated with an image (for example the elimination of stop words may be implemented prior to the detection of patterns).

According to the example in FIG. 5, the method may comprise a search 3421 for patterns common to several images and potentially for their positions within these images (in order to detect a potential recurrence of their positions within the sequence of the images).

The identifications 3422 of patterns by each analyzed image may be used for the distribution 342 of the images into classes. As is shown in FIG. 5, the method may comprise obtaining a candidate distribution into “x” classes of images, each class identified then being associated with a particular combination of patterns. The combination of patterns associated with a class (and hence the associated candidate distribution) may take into account, in some embodiments, a proximity relationship between the positions of several patterns within the various images. For example, in some embodiments, a proximity between absolute positions of at least two patterns within each of the at least two images where they are present, or relative positions of at least two patterns within the images where they are present, respectively, with respect to another element also present within these images (for example another pattern present within these at least 2 images) may be taken into account. For example, a recurrence of such a proximity between several images may be taken into account, as illustrated by the blocks 811, 812, 813 of the images 810, 820, 830 in FIG. 8, for grouping the images.

As in the embodiments illustrated in conjunction with FIG. 4, this identification of classes may for example take into account a minimum or maximum number or percentage of images per class, so as to obtain relatively uniform classes (in terms of number of elements), or a desired number x of classes for example.

In the embodiments illustrated in conjunction with FIG. 5, in a similar manner to what has been described in relation with the embodiments in FIG. 4, the method may comprise an assignment of a confidence level to a pattern (for example such as a ratio between the number of images of the class where an occurrence of the pattern is present and the total number of analyzed images where an occurrence of this pattern is present), and an assignment of a confidence score to a class and/or to a distribution.

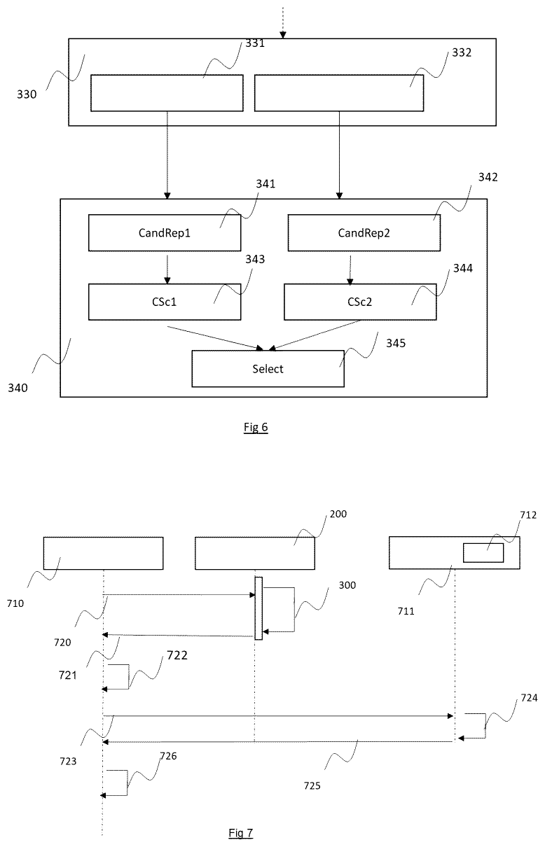

According to some embodiments of the method of the present application, the two analyses 331, 332 detailed hereinabove may be carried out sequentially and/or in parallel (as illustrated in FIG. 6), the method then comprising a selection 342 of at least one of the distributions obtained. This selection may for example take into account at least one selection criterion based for example on the compliance with at least one configuration parameter, over a processing time and/or a memory occupation. In some embodiments, the selection may take into account a confidence score assigned to at least one class of at least one of the distributions (as detailed hereinabove).

As indicated hereinbefore, in some embodiments, the method may comprise an association of a textual label with at least one of the classes.

This association may be optional in some embodiments. The association of a label with a class may comprise an association of this label with all the images distributed into this class.

This labelling may for example be carried out by a user via a human-machine interface of said device 200.

In some embodiments, the method may comprise, prior to the analysis, obtaining at least one configuration datum used to define a value of at least one parameter useful to the method of the present application. This may for example be at least one configuration datum accessible via at least one configuration file, or at least one configuration datum obtained via a user interface (or received from a third-party device). Such parameters may, in some embodiments, have default values accessible via a storage means of the device for example, or be calculated automatically by the method of the present application. This step may be optional in some embodiments.

It goes without saying that the configuration data may vary depending on the embodiments. For example, in some embodiments, at least one configuration datum may be obtained from amongst the following data:
a minimum number of desired clusters (for example from around 5 to around ten clusters);
a number of desired clusters (for example from around ten to a few tens of clusters, such as 12, 20, etc.);
a maximum number of desired clusters (for example of the order of a hundred clusters, such as 100);
a fixed, maximum, minimum and/or average number of blocks dividing up an image (as described in more detail hereinbelow), for example a number of blocks of the order of a hundred or of a few hundred blocks (such as 99),
an indication relating to a processing to be performed. This may for example be a Boolean value indicating whether a filtering relating to stop words (for their elimination) is to be applied or otherwise;
a minimum and/or maximum number of occurrences of visual items on which candidate distributions are to be based;
an indication relating to the analysis and the distribution to be applied (selection of an analysis/distribution based on a number of occurrences of items, selection of an analysis/distribution based on the presence of patterns, or selection of both analysis/distribution (as illustrated in FIG. 6));
a minimum confidence score to be met (for example a minimum coefficient of 0.9 when the scores go from 0 to 1).

As described earlier, some of these configuration data (for example the number of classes into which the images are to be distributed, or the maximum number of such classes when the exact number is defined automatically by the method of the present application) may be optional in some embodiments. These configuration parameters may be used, for example, as criteria to be adhered to by a candidate distribution during the selection of a distribution.

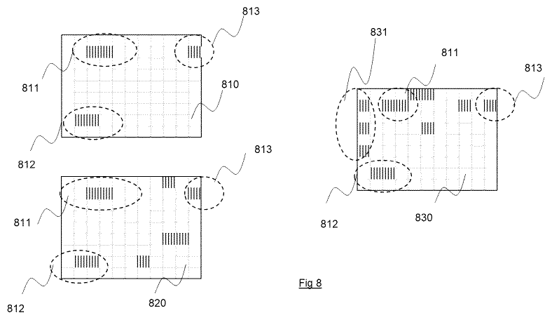

With reference to FIG. 7 and by way of example, exchanges of streams between some of the devices of the system 100 for the implementation of the method of the present application, for an application to the training of a neural network, are now described.

In the example illustrated, the method may for example be executed on the device 200. The device 200 receives 720 images from another device 710 (for example one of the terminals of the system 100) which it processes 300 as described hereinbefore in conjunction with FIGS. 3 to 6 for distributing these images into classes. Information representative of this distribution may be supplied 721 to the device 710. Such representative information may for example comprise at least one of the following elements: a number of classes, identifiers and/or labels of the classes, a number or a percentage of images for at least one class, lists of images (or of image identifiers) by class, lists of data structures each associating an image identifier with a class, of the images associated with a metadatum indicating their class, etc.

The device 710 may for example name the classes as it likes 722 and associate its class with each distributed image (so as to thus constitute a database of images annotated by their class). The device 710 may supply 723 these annotated images to a device 711 of the system 100 as a set of learning data for an artificial intelligence model 712. The device 711 may subsequently carry out 724 the training of the model 712 by virtue of the received annotated images. In some embodiments, the parameters of the learned model may be supplied 725 to the device 710, which may subsequently use (infer) 726 the learned model on other images in order to the classify them.

1. A method for classifying images, the method implemented in an electronic device, the method comprising:
obtaining images comprising a plurality of visual items; and
distributing the images into a plurality of classes, according to at least a number of occurrences, within said images, of visual items extracted from said images.

2. The method of claim 1, wherein said classes are identified during said distribution.

3. The method of claim 2, further comprising labelling the identified classes.

4. The method of claim 3, wherein said labelling is carried out automatically.

5. The method of claim 1, wherein said images distributed into said plurality of classes are used for training a neural network to classify other images according to said plurality of classes.

6. The method of claim 1, wherein said method is implemented locally to said electronic device.

7. The method of claim 1, wherein said visual items are words, groups of words and/or graphical objects from said images.

8. The method of claim 7, where the method comprises replacing at least a first word, from amongst said visual items, by at least a second word.

9. The method of claim 1, wherein said method comprises obtaining the positions of said extracted visual items within said plurality of images.

10. The method of claim 7, wherein said visual items are words and/or groups of words and wherein said method comprises, for an analyzed image from said plurality of images, associating said analyzed image with the number of occurrences of the individual visual items extracted from said analyzed image.

11. The method of claim 10, wherein said method comprises eliminating, in said individual visual items associated with said analyzed image, at least one stop word.

12. The method of claim 10, wherein said method comprises eliminating, in said individual visual items associated with the analyzed images from said plurality of images, visual items associated with a number of images greater than a desired number of classes.

13. The method of claim 10, wherein said method comprises:
grouping of the individual visual items from said analyzed image taking into account various values of said numbers of occurrences of individual visual items within said analyzed image; and
obtaining at least one candidate distribution of said images for a candidate value of the various numbers of occurrences, taking into account individual visual items common to at least two grouped analyzed images for said candidate value.

14. The method of claim 9, wherein said distribution takes into account patterns relating to the positions of said visual items within said images from said plurality of images and present in at least two analyzed images from said plurality of images.

15. The method of claim 14, where said method comprises:
detecting at least one pattern within analyzed images from said plurality of images;
associating said detected pattern with the analyzed images from said plurality of images in which an occurrence of said pattern has been detected; and
obtaining at least one candidate distribution of said analyzed images taking into account at least a number of occurrences of at least one pattern associated with at least two of said analyzed images.

16. The method of claim 14, wherein said distribution takes into account the positions of said patterns within said analyzed images.

17. The method of claim 13, wherein said method comprises assigning a confidence score to a class, taking into account an occurrence of at least one visual item and/or of at least one pattern associated with at least one image of said class in at least one other image of at least one other class.

18. The method of claim 13, wherein said method comprises obtaining at least two candidate distributions and where said distribution is chosen, from amongst said candidate distributions, taking into account a desired number of classes and/or the confidence score assigned to at least one of the classes of said candidate distributions.

19. The method of claim 1, further comprising modifying at least one of said obtained images prior to an analysis of said images.

20. An electronic device comprising at least one processor configured for an image classification comprising:
obtaining images comprising a plurality of visual items; and
distributing the images into a plurality of classes, according to at least a number of occurrences, within said images, of visual items extracted from said images.

21. (canceled)

22. A non-transitory computer-readable recording medium instructions which, when executed by a processor of an electronic device, cause the electronic device to implement a method for classifying images, the method comprising:
obtaining images comprising a plurality of visual items; and
distributing the images into a plurality of classes, according to at least a number of occurrences, within said images, of visual items extracted from said images.
